(19) United States
(12) Patent Application Publication
(10) Pub. No.: US 2009/0272278 A1
(43) Pub. Date: Nov. 5, 2009

(54) ADJUSTABLE GRILL APPARATUS WITH BURNER CONTROLS AND SUPPORTS

(75) Inventors: Pieter J. von Herrmann, Shaker Hts., OH (US); Adam Pintz, Strongsville, OH (US); David Frederick, Medina, OH (US); Bai Han, Westlake, OH (US); William Thompson, Shaker Hts., OH (US)

Correspondence Address: JEANNE E. LONGMUIR, 2836 CORYDON ROAD, CLEVELAND HEIGHTS, OH, 44118, US

(73) Assignee: SOLARFLO CORPORATION, Bedford Heights, OH (US)

(21) Appl. No.: 12/395,392

(22) Filed: Feb. 27, 2009

Related U.S. Application Data
(60) Provisional application No. 61/032,039, filed on Feb. 27, 2008.
(60) Provisional application No. 61/111,804, filed on Nov. 6, 2008.
(60) Provisional application No. 61/122,047, filed on Dec. 12, 2008.

(51) Int. Cl. A47J 37/07; F23D 14/12; F24C 15/10

(52) U.S. Cl. 99/450; 431/328; 126/39 J

(57) ABSTRACT

An adjustable grill apparatus having a movable radiant gas burner unit. The adjustable grill apparatus is supported on the top cooking surface of a conventional outdoor grill. The movable radiant gas burner unit is supported on a support assembly having side panels and support panels for pivoting adjustable positioning between a substantially vertical position supported on the grill and substantially horizontal positions supported on the support assembly. The movable radiant burner unit is operable at a constant or variable operating temperature between high and low temperatures to obtain the desired cooking rate for the food item to be cooked.

### CROSS-REFERENCE TO RELATED APPLICATIONS

The present application claims priority from pending U.S. patent application Ser. No. 11/833,967 filed Aug. 3, 2007; No. 61/032,039 filed Feb. 27, 2008; No. 61/111,804 filed Nov. 6, 2008 and No. 61/122,047 filed Dec. 12, 2008, the entire subject matters of which are incorporated herein by reference.

### FIELD OF INVENTION

The present application is directed to an adjustable grilling apparatus, and more particularly to a grill having an adjustable radiant burner unit with improved burner controls and supports, wherein the associated grill may be positioned in any number of angles from and including a vertical position to a horizontal position.

### BACKGROUND

Cooking grills with radiant burners are often used in connection with conventional grilling systems. Where the burner is a gas unit, the radiating surface of the burner is typically a ceramic plate with densely spaced holes through which a combustible mixture of gas and air flows. The air/gas mixture is ignited at the ceramic surface and combustion takes place at the surface as well as partially in the holes. The velocity of the air/gas mixture through the holes is no less than the backward flame propagation velocity, so that the flame does not travel into the plenum behind the ceramic plate.

Past systems of the type disclosed, for example, in U.S. Pat. Nos. 3,547,097 and 6,012,444 provide a radiant burner structure included in a grilling system. Such units disperse the air/gas mixture within a chamber adjacent to the ceramic plate. The air/gas mixture is dispersed by a large single tube or multiple gas tubes of unequal length positioned longitudinally within the chamber, which dispersion attempts to provide equal gas distribution within the chamber and thus equal heating across and throughout the ceramic plate or plates.

It is important to assure equal heating across and throughout the surface of the ceramic plate to provide maximum and optimum radiation from all parts of the surface, and thus even cooking or heating. At the same time, the flammable gas under the ceramic plate must be the proper mixture of air and gas. For example, methane gas and air mixtures may have a variety of mixture ratios, but radiation efficiency, although difficult to measure, is believed to be optimal for complete combustion at ratios of approximately 10:1. For propane gas and air mixtures, radiation efficiency is more likely optimal for complete combustion at ratios of approximately 24:1.

A high velocity gas jet induces a sufficient quantity of air into the mixing tube or diffuser tube. The quantity of air/gas mixture needed to supply the entire radiating ceramic surface of the unit requires the mixing or diffuser tube to have a relatively large diameter. In prior art grilling systems, the large mixing or diffuser tube diameter was responsible for the depth or thickness of the burner unit body behind the ceramic radiating surface, i.e. the overall thickness of the unit. Thus, such prior art burner units are generally thick or deep in the direction “d,” or the height or thickness of the burner unit. This height dimension limits use of the burner units to conventional sized ovens and other applications of conventional size, which are of considerable bulk.

The designs of prior art grilling systems were also limited by the size of the burner units. Such burner units were not generally movable to a desired location for specific grilling applications. Additionally, such burner units were often limited in their adjustability.

### SUMMARY OF THE INVENTION

The adjustable grill apparatus disclosed here includes a radiant burner unit that is shallow in the direction perpendicular to the radiating surface, or a thin radiating burner unit. The burner unit is used in connection with a support assembly which enables the burner unit to be adjusted within a grilling system. As a result, the burner unit may be used in a variety of applications having a variety of positions. The present grilling system is adjustable so that the burner unit is positioned for both a broiler application, located horizontally above the food, and/or from a rotisserie application, located vertically at the side of the food items to be cooked, and at points in between.

The adjustable grill apparatus of the present application may be used in connection with an outdoor grill or, as a stand alone portable grilling or cooking system. The adjustable grill apparatus includes a movable radiant burner unit, which may be gas or electric, and a support assembly. When the apparatus is used on an outdoor grill, the burner unit may be positioned for broiling over the top of the items to be cooked. Alternatively, when in a rotisserie configuration, the burner unit may be positioned vertically with respect to the items to be cooked, which are supported on a rotating unit supported on the support assembly. When provided as a stand alone system, the burner unit may be positioned as a heating burner unit, beneath the items to be cooked.

To enable movement between the horizontal and vertical positions, the burner unit is mounted within a support assembly. Numerous embodiments of the support assembly are provided. The support assembly includes two side panels, secured one on each side of the burner unit assembly. Each panel has a pivot point for pivoting or sliding engagement with, and movement about, a corresponding support panel to achieve various positions and heights. The support panels are supported within the grill apparatus on the grilling surface. Each support panel includes a pivot or sliding slot or point for engagement with the support panel, generally by a threaded fastener or pin. Additionally, inner and outer stops are provided on the support panel. The outer stops support the burner unit on the grill surface. The inner stops support the burner unit when it is moved to the broiler location. In the rotisserie location, the burner unit is supported along the rear surface of the grill.

Unlike prior art gas grilling systems which supply or inject the air/gas mixture at the end of the burner unit, the air/gas mixture is introduced to the device via multiple side inlets. Although in one embodiment, multiple staggered length mixing tubes are provided from end inlets. In a gas fired burner unit, a flexible gas supply is provided along the edge of the burner unit and guides the gas to the appropriate gas inlet orifice locations.

The radiant gas burner unit also includes improved burner controls over prior devices. The infrared gas burner unit is provided with high and low gas settings. The high setting burns at approximately 46,000 BTU/H input. The low setting burns at approximately 16,000 BTU/H input. The two setting capability allows both searing and slow cooking, and eliminates the need to adjust either the burner height or the rack height to achieve this capability.

### DESCRIPTION OF THE DRAWINGS

FIG. 1 is a schematic, perspective view of the adjustable grilling apparatus of the present application shown engaged on the top cooking surface of an outdoor grill;

FIGS. 2a-2e schematically illustrate perspective, top, end, side and bottom views, respectively of the gas burner unit used in the adjustable grilling apparatus of FIG. 1;

FIGS. 3a and 3b schematically illustrate perspective and end views, respectively, of a burner unit and a grill engaged at a 45 degree angle within the support assembly of the adjustable grilling apparatus of the present application;

FIG. 4 schematically illustrates the burner unit and a grill engaged within the support assembly in an alternate broiling position;

FIG. 5 schematically illustrates the burner unit engaged within the support assembly in an alternate rotisserie position;

FIG. 6 schematically illustrates a vertical end plate of the support assembly;

FIG. 7 schematically illustrates a perspective view of the top plate of the support assembly;

FIG. 8 schematically illustrates a box frame member which forms a portion of the gas burner unit; and

FIG. 9 schematically illustrates alternate side views of the positions and range of positions the grill rack may be moved to and through within the adjustable grilling apparatus.

FIG. 10 is a perspective view of a second alternative adjustable grilling apparatus of the present application shown with the radiant burner unit in the rotisserie location on a grill;

FIG. 12 is a front view of the adjustable grilling apparatus of the present application shown with the radiant burner unit in the broiler location on a grill;

FIG. 13 is a partial, perspective view of the front, left hand side of the adjustable grilling apparatus of the present application shown with the radiant burner unit in the broil location on a grill;

FIG. 14 is a partial, perspective view of the front, right hand side of the adjustable grilling apparatus of the present application shown with the radiant burner unit in the rotisserie location on a grill;

FIGS. 15a, 15b, 15c and 15d illustrate the top, front, side and perspective views of the burner side panel of the support assembly;

FIGS. 16a, 16b, 16c and 16d illustrate the top, front, side and perspective views of the burner support panel of the support assembly;

FIGS. 17a, 17b, 17c and 17d illustrate the radiant gas burner unit adapted for burner control;

FIG. 18 schematically illustrates operation of the low gas mode of the radiant gas burner unit with burner control;

FIG. 18a schematically illustrates operation of the high gas mode of the radiant gas burner unit with burner control;

FIG. 19 is a partial, schematic illustration of a top view of a dual gas manifold assembly for the radiant gas burner unit;

FIG. 20 is a partial, schematic illustration of a bottom view of the dual gas manifold assembly for the radiant gas burner unit;

FIG. 21 is a perspective view of a third alternative adjustable grilling apparatus of the present application shown with the radiant burner unit housed within a closed grill;

FIG. 22 is a perspective view of the third alternative adjustable grilling apparatus of FIG. 21 shown with the grill hood open and the radiant burner unit in the rotisserie position on the grill;

FIG. 23 is a front view of the adjustable grilling apparatus of FIG. 22 shown with the radiant burner unit in the rotisserie position on a grill;

FIG. 24 is a partial perspective view of the adjustable grilling apparatus of FIG. 22 shown with the radiant burner unit moving from the rotisserie position to a first low broiler position;

FIG. 25 is a perspective view of the adjustable grilling apparatus of FIG. 22 shown with the radiant burner unit in the first low broiler position on a grill;

FIG. 26 is a partial perspective view of the adjustable grilling apparatus of FIG. 25 showing the cooking area clearance provided on a grill;

FIG. 27 is a perspective view of the adjustable grilling apparatus of FIG. 22 shown with the radiant burner unit moved to the second high broiler position on a grill;

FIG. 28 is a partial perspective view of the adjustable grilling apparatus of FIG. 27 showing the cooking area clearance provided on a grill in the high broiler position;

FIG. 29 is a partial perspective view of the adjustable grilling apparatus of FIG. 25 showing the grill hood being closed when the radiant burner unit is in the first low broiler position;

FIG. 30 is a partial perspective view of the adjustable grilling apparatus of FIG. 27 showing the grill hood being closed when the radiant burner unit is in the second high broiler position;

FIG. 31 schematically illustrates operation of the low gas mode of an alternate side feeding embodiment of the adjustable grilling apparatus of the present application; and

FIG. 32 schematically illustrates operation of the high gas mode of an alternate side feeding embodiment of the adjustable grilling apparatus of the present application.

### DETAILED DESCRIPTION OF THE PRESENT APPARATUS

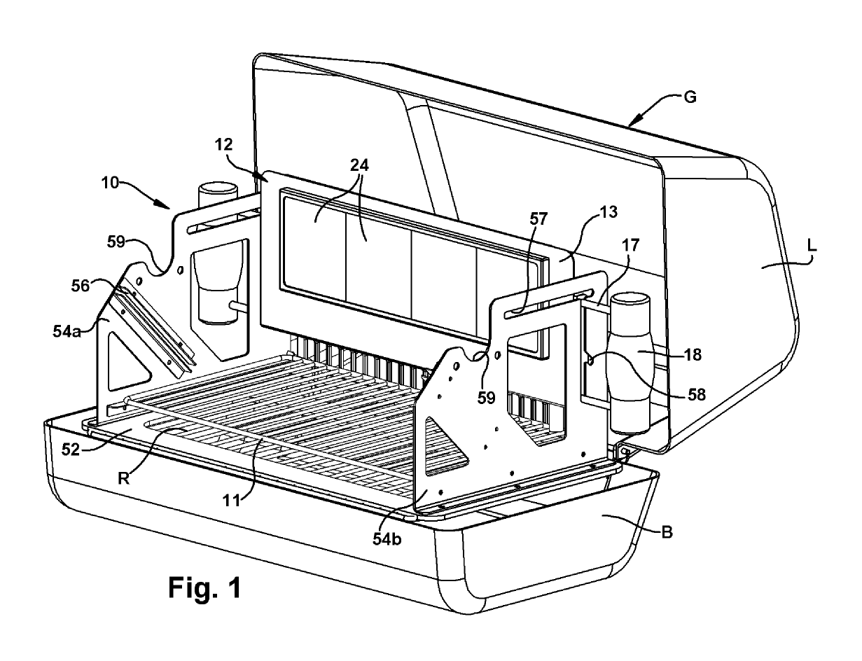

The present application provides an improved adjustable grilling apparatus 10. FIG. 1 illustrates the unit 10 shown engaged on the top cooking surface of a grill G. The grill G illustrated may be any type of conventional grill, such as an outdoor charcoal or gas grill having cooking heat supplied from beneath the item to be cooked. The illustrated grill G includes a hood or lid L, and a base B having a cooking rack or top cooking surface R. It should be understood that throughout this application, were elements of the present grill apparatus 10 are referenced in various embodiments and with similar structures, they are referenced with the same designation. Differences between the structures will be highlighted where necessary.

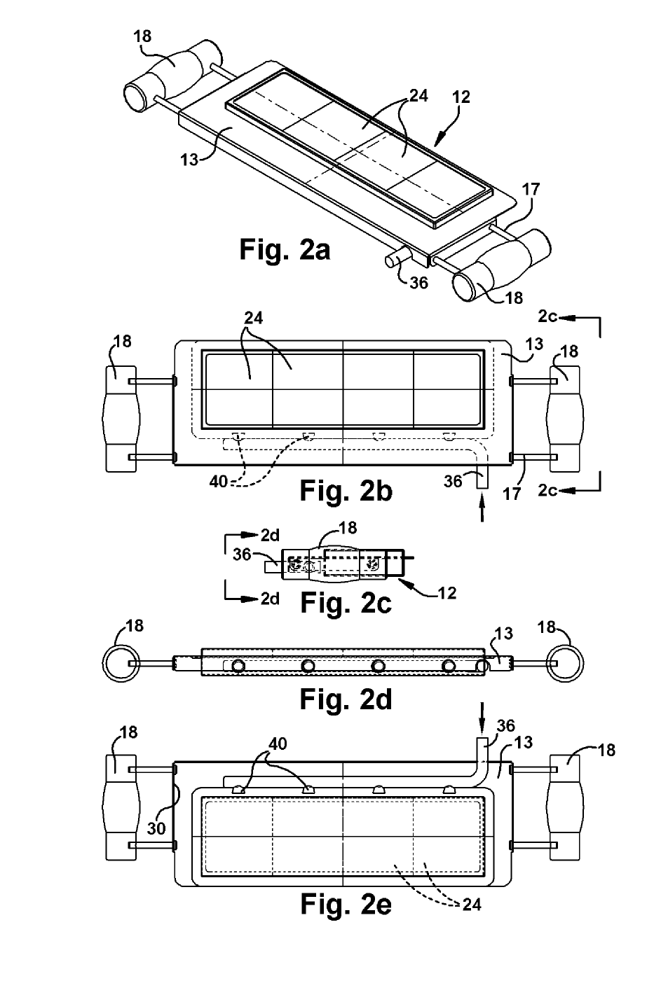

The first grilling apparatus 10 embodiment of FIG. 1, includes a movable radiant gas burner unit 12 having two long side walls 14 and two shorter side walls 16. As shown in FIGS. 2a-2e and 8, the unit 12 includes a box frame member 13. Handles 18, of any suitable material, such as wood, metal or heat resistant polymer materials, are provided adjacent each of the two shorter side walls secured to the box frame member 13 using conventional spacers 17 and fasteners, to enable the user to move and adjust the unit 12 to the desired cooking position. As shown in FIGS. 2a, 2c, 2d and 8, the box frame member 13 is provided with an opening for receiving infrared ceramic burner plates 24, and outwardly extending flanges 30 for engagement with handles 18 and for securing the handles to the burner unit 12.

A gas manifold or gas supply 36 is also provided. The gas supply 36 provides gas to gas outlets 40 located adjacent infrared ceramic burners or plates 24. As shown in FIGS. 2a-2e, multiple commercially available infrared ceramic plates 24 may be used to form a substantially continuous infrared burner surface. Alternatively, a one-piece infrared ceramic burner or plate 24 may be provided. Infrared ceramic plates or grid plates of the type used in the preferred embodiment are available, for example, from entities such as Apogee Engineering Ceramics in Brantford, Ontario, Canada, or Saint-Gobain Ceramics and Plastics, Inc., at www.combustionsolutions.saint-gobain.com. However, it is understood that materials other than ceramic, such as steel mesh may also be used.

The infrared ceramic gas burner plates 24 are held within the box frame member 13 of the burner unit 12. In the illustrated embodiment, where as many as 5 plates 24 may be provided, a joint is provided between the desired number of infrared ceramic panels 24, which is preferably a commercially available flexible adhesive material M capable of withstanding the heat generated by the burner during use, which may be in the range of up to 1500° Celcius.

The grilling apparatus 10 also includes a grill rack 11 and a support assembly 50 for supporting and enabling adjustment of the position of the burner unit 12 with respect to the item to be cooked. As shown in FIG. 1, the support assembly 50 includes a top plate 52, which is best illustrated in FIG. 7. Secured to the top plate 52, are two side plates 54a, 54b. The side plates 54a, 54b are vertically secured, whether by welds or conventional fasteners, to the top plate 52.

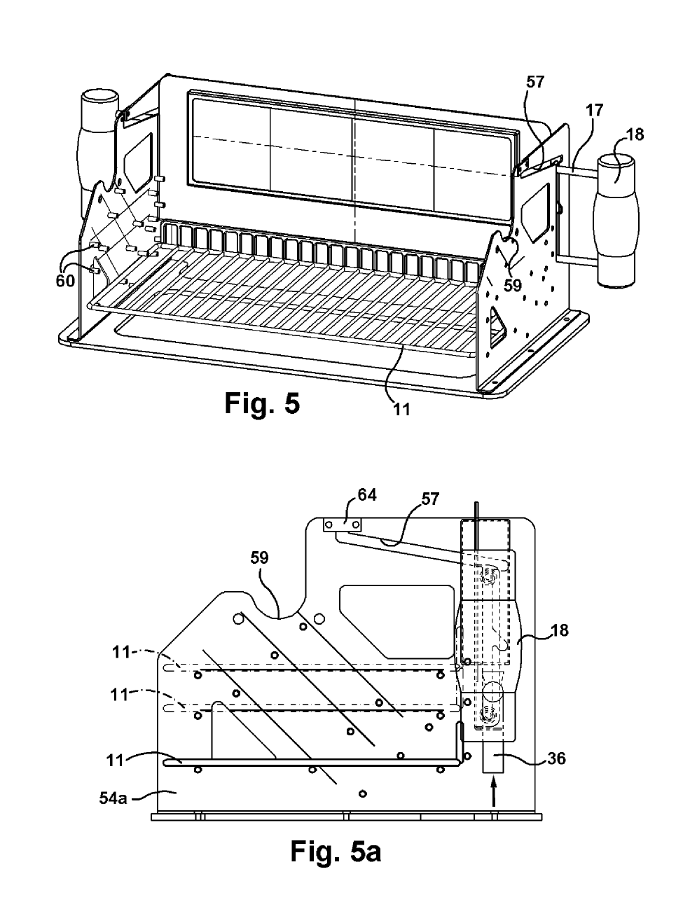

One configuration for the side plates is illustrated in FIG. 1, where slotted grooves 56 are provided engaged in opposing positions on each of the side plates 54a, 54b. In this configuration, the grill rack 11 may be moved from the horizontal position shown, to an angled position (approximately 45 degrees) with respect to the top plate 52, which is positioned over the cooking surface of the grill G, and an angled position with respect to the burner unit 12, shown in a vertical position. In the FIG. 1 embodiment, the spacers 17, which mount the handles 18 to the burner unit 12, are movable within slots 57, between the vertical position shown, as well as an angled position when positioned in a notch 58, or a horizontal position within the horizontal slots 57. In the vertical position or the rotisserie position shown in FIG. 1, and in the alternative embodiment of the rotisserie position shown in FIG. 5, the food item to be cooked may be manually or mechanically rotated on a conventional rotisserie rod which would support the food item, and be supported within the rounded grooves 59 provided on the top of the side plates 54a, 54b.

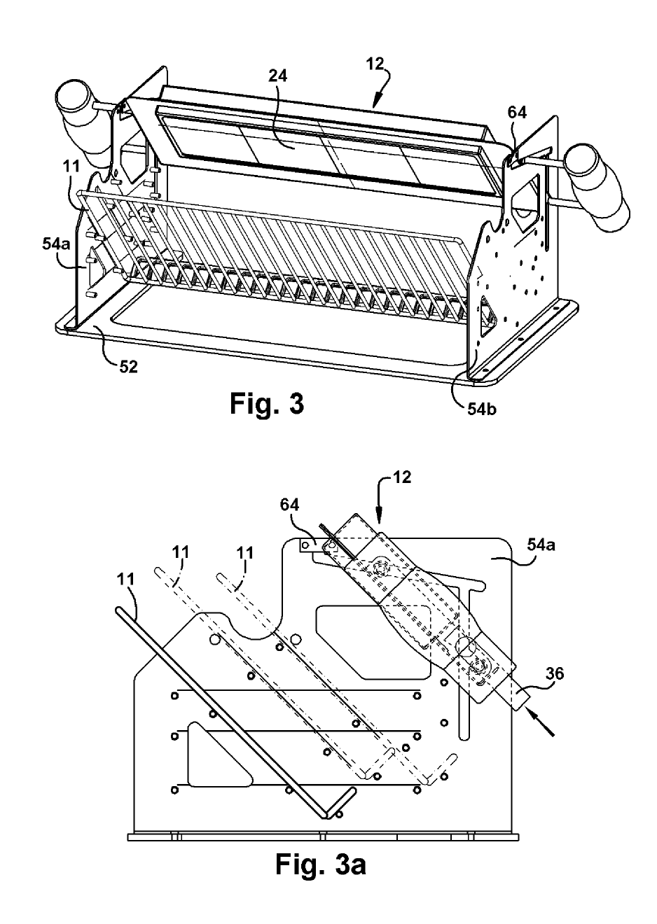

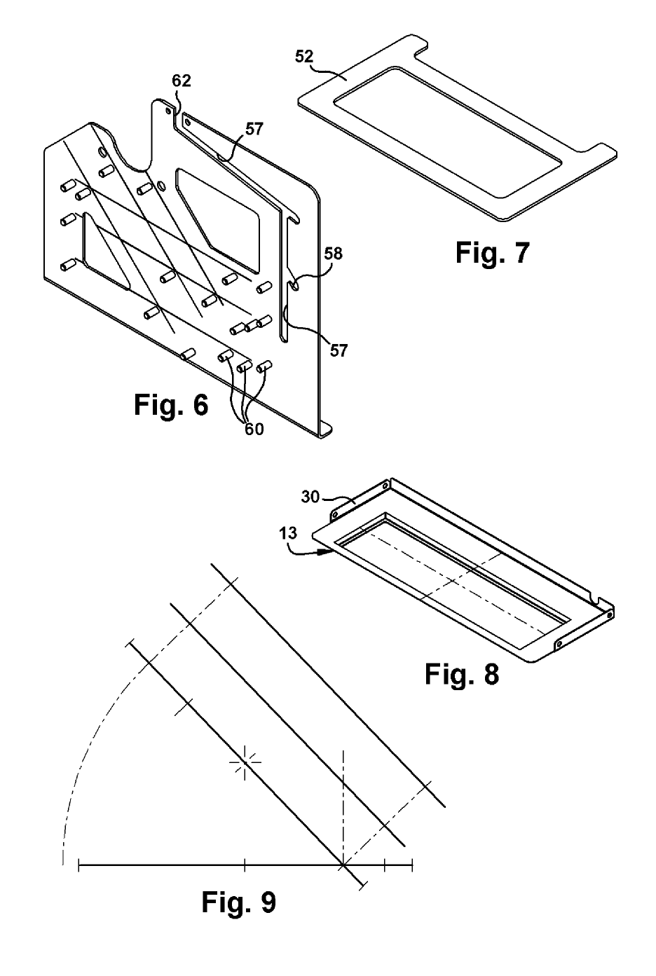

Another configuration for the side plates is illustrated in FIGS. 3-6. In this embodiment, the side plates are provided with numerous posts 60, which are secured to the side plates 54a, 54b, by either welds or conventional fasteners, for supporting the grill rack 11 in a variety of desired cooking positions. Additionally, an opening 62 is provided in the horizontal slots 57, which is shown covered by a slot clamp 64 to prevent removal of the burner unit 12 from the support assembly 50. However, the slot clamp 64 may be secured to the side plates by conventional fasteners, such that the slot clamp 64 may be removed, as shown in FIG. 6, so that the burner unit 12 may be removed from engagement with the support assembly 50, and taken for repair, replacement or use as a stand alone burner unit.

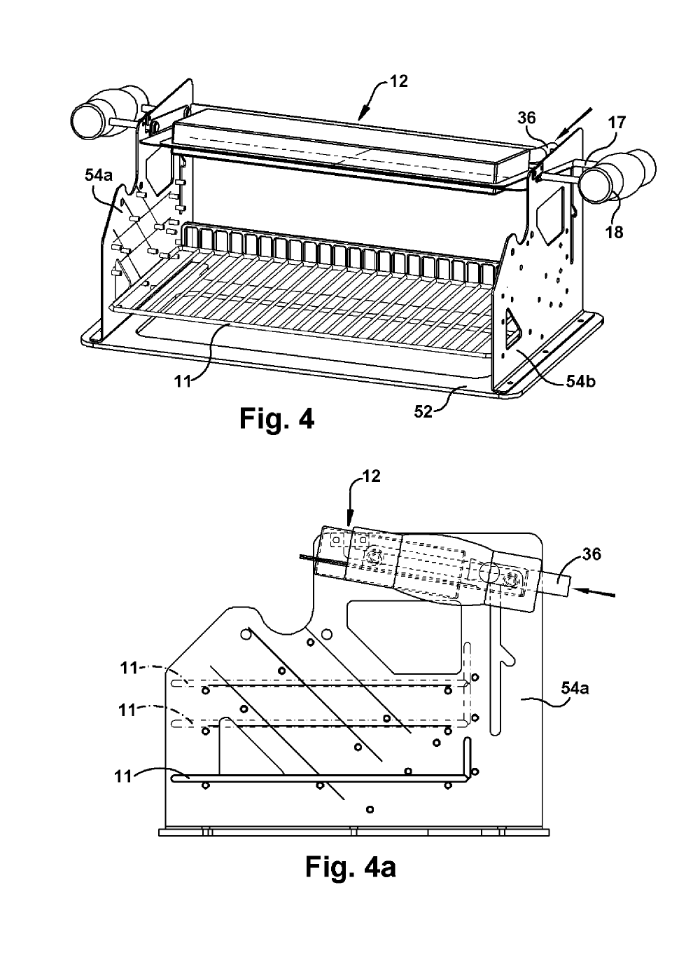

As shown in FIG. 4, the burner unit 12 is positioned in a substantially horizontal position over the food item to be cooked, or in a top or broiling position. The grill rack 11 may be mounted on low posts 60 along the bottom of the side plates, or along posts 60 positioned in two vertically higher positions closer to the burner unit 12, as shown schematically in FIG. 4a.

In the FIG. 3 embodiment, the burner unit 12 is shown moved to an optional angled or slanted cooking position. Likewise, the grill rack 11 may also be moved to an angled position, and the distance between the grill rack 11 supporting the food item to be cooked may also be moved toward or away from the burner unit 12, as schematically illustrated by the optional positions of the grill rack 11 shown in FIG. 3a and also in the rotisserie position option of FIG. 5a.

The optional positions of the grill rack 11, which is mounted on fixed or movable posts 60, are also illustrated schematically by the lines in FIG. 9. By providing optional distance positions between the burner unit 12 and the food item to be cooked on the grill rack 11, the user is able to adjust the cooking rate as desired. A quick sear, for example, may be followed by a slower broil of a thick steak. Such cooking options are desirable, to enable the meat juices to permeate the meat, versus falling onto the cooking element. Additionally, the adjustable grilling apparatus of the present application eliminates the need for a special, dedicated searing station, and may also be used as a warmer following cooking. Other problems, such as grease falling on the heating element are eliminated with top or side cooking. Also, the drip catcher, which is typically used to prevent food from falling onto the heating element, is no longer an interference with the heating element. The top cooking position is also ideal for melting cheese on food items. Still further, the adjustable grilling apparatus enables food to be broiled from the top and grilled from the bottom, at the same time or at different times on the same items or on different items.

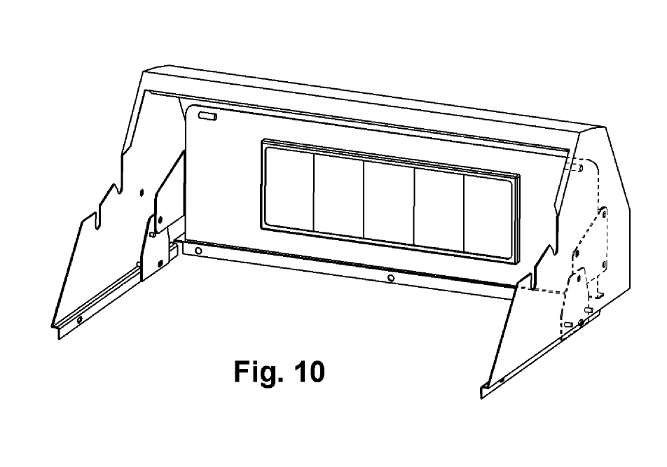

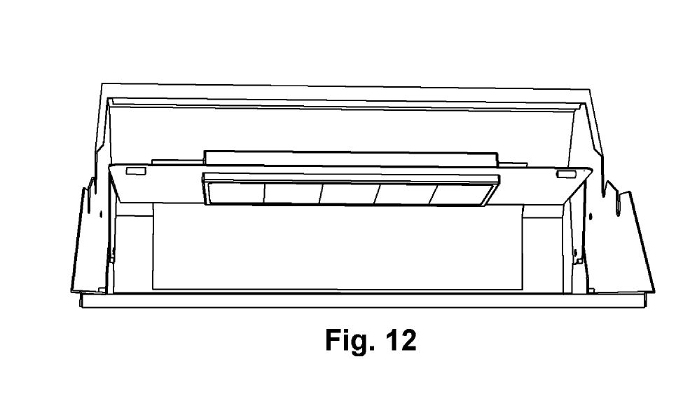

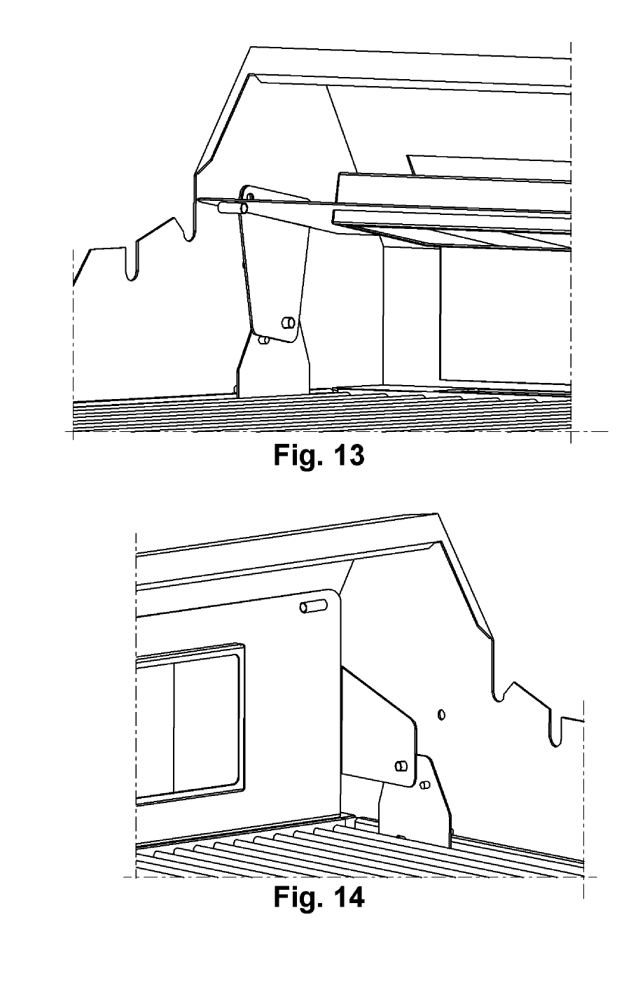

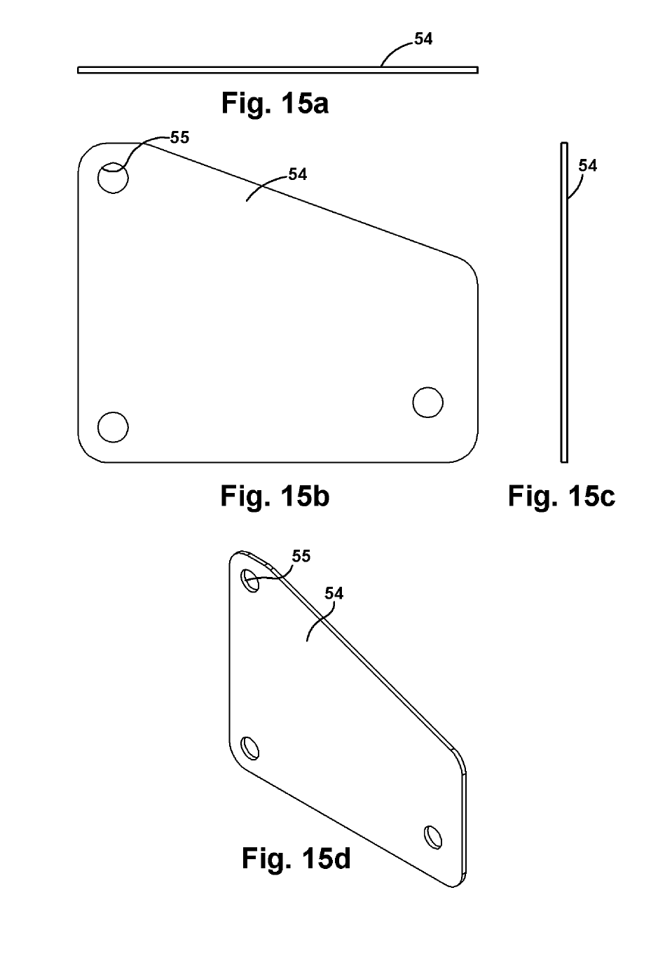

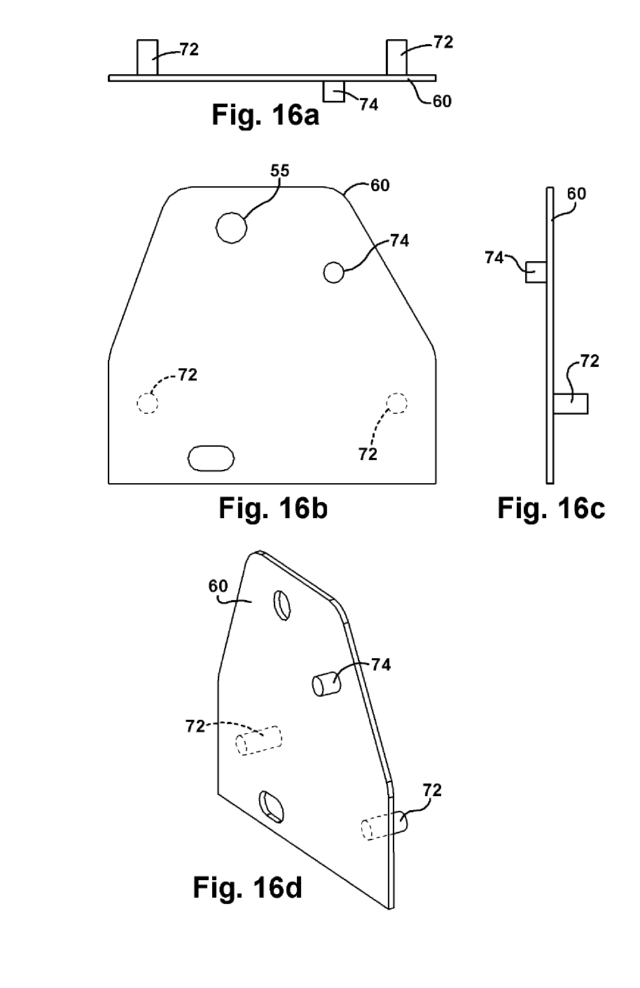

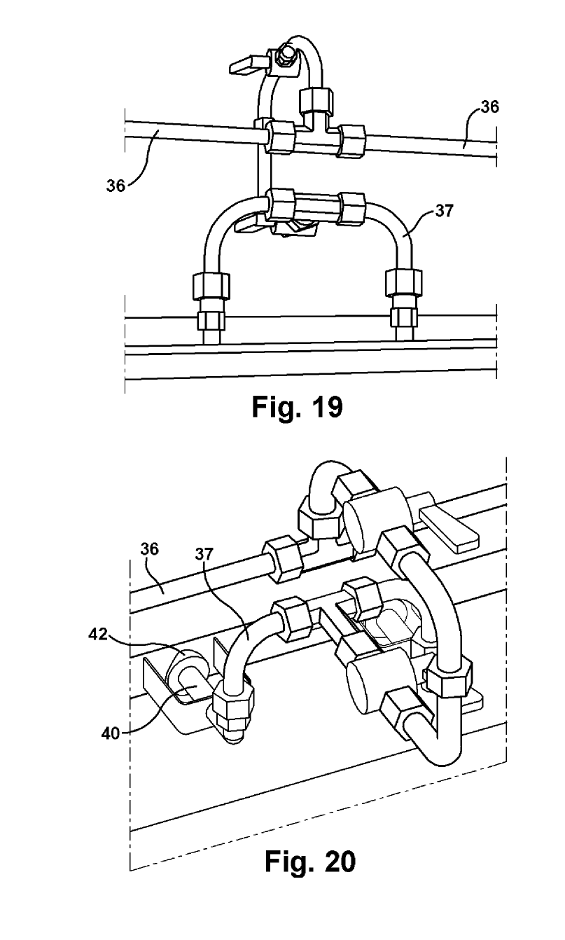

A second alternate embodiment of the present apparatus is shown in FIGS. 10 to 20. The grilling apparatus 10 includes the movable radiant burner unit 12. In this illustrated embodiment, the radiant burner unit 12 again has two long side walls 14 and two shorter side walls 16. As shown in FIGS. 10-14, the unit 12 includes a box frame member 13. A handle 18 may be provided at the front of the box frame member for moving the unit. Provided adjacent each of the two shorter side walls secured to the box frame member 13 are side panels 54a, 54b, as shown in FIGS. 15a-15d. The side panels 54 include a pivot opening 55, and are secured via welding or conventional fasteners to the box frame member 13. Corresponding support panels 60 of the type shown in FIGS. 16a-16d are provided adjacent each side panel 54. The support and side panels 60, 54, respectively, are engaged together for pivoting engagement about a pivot point at the pivot opening 55 via a post or conventional fastener. The support panels 60 are supported within the grill apparatus supported on the grilling surface. Two outer stops 72 are provided which extend from the base of each support panel 60 for supporting engagement of the burner unit 12 on the grill G rack R. An inner stop 74 extending from each support panel 60 engages the side panel 54 to support the burner unit 12 when it is moved to the broiler location, as shown in FIG. 13. In the rotisserie location, the burner unit 12 is supported along the rear surface of the grill G, as shown in FIG. 14.

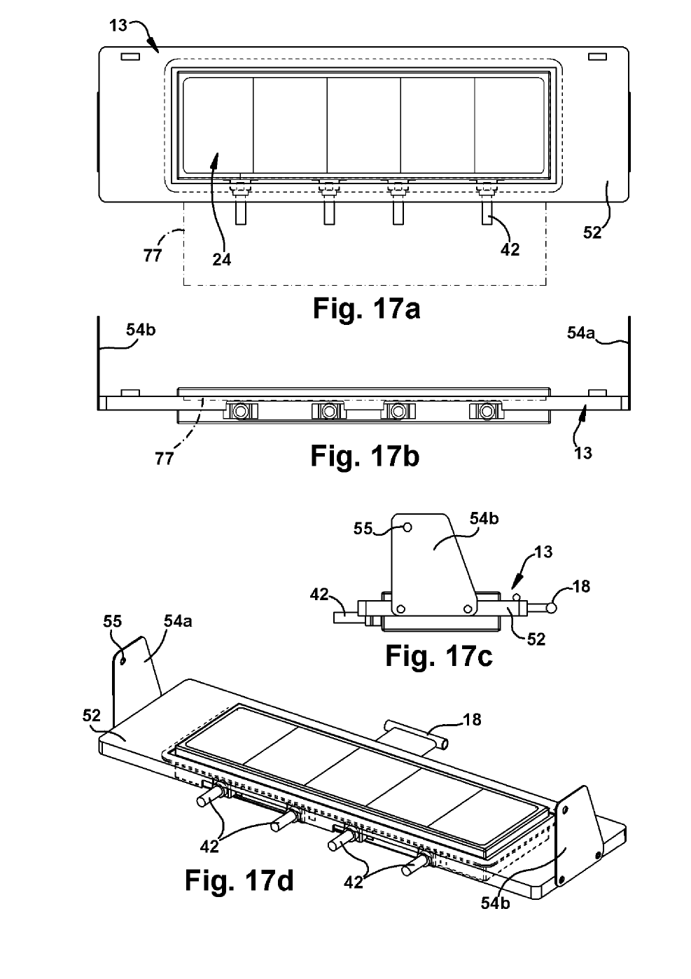

As shown in FIGS. 10-14, the box frame member 13 is provided with an opening for receiving infrared ceramic burner plates 24, and outwardly extending flanges 30 for engagement with the side panel and for securing a handle 18 to the burner unit 12, as shown in FIGS. 17c and 17d.

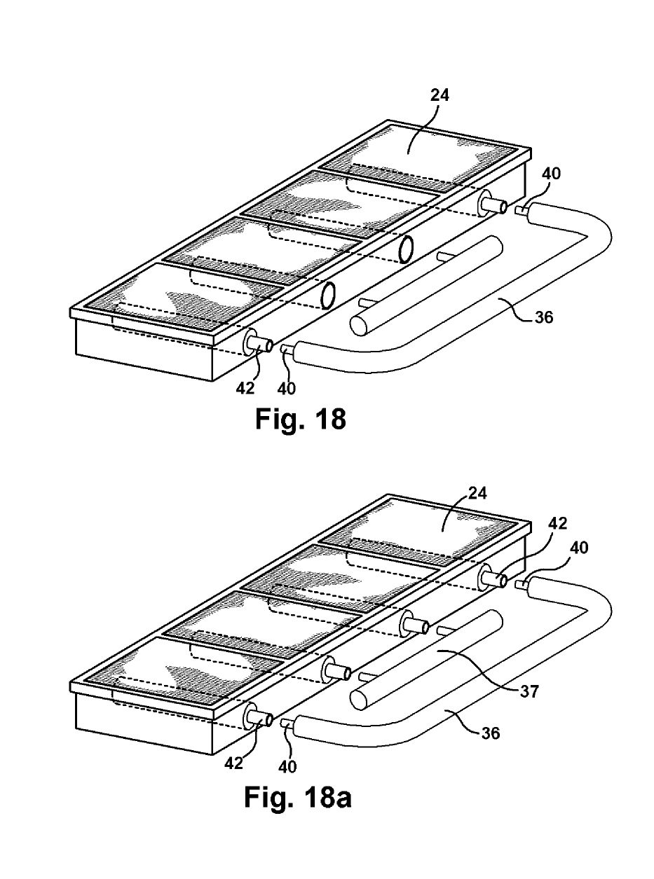

In the burner unit 12 of FIGS. 17a-17d, having improved burner controls, two gas supply manifolds 36, 37 are provided. The two gas manifolds 36, 37, shown in FIGS. 18-20, provide gas to four gas outlets 40 located adjacent infrared ceramic burners or plates 24. The gas is received by four corresponding plenum entrance holes 42 as shown in FIGS. 17a-19. As shown in the first embodiment, multiple commercially available infrared ceramic plates 24 may be used, or a one-piece infrared ceramic burner or plate 24 may be provided.

The use of two gas manifolds supplying gas to 4 gas entrances makes a high and low gas setting possible. With the use of multiple gas entrances, the open plenum design permits even gas burning across the multiple ceramic surfaces of the burner unit. Each gas manifold 36, 37 supplies gas to gas orifices or plenum openings along the long wall of the burner unit. One of the gas manifolds 36, supplies gas to the two outer gas orifices 42 which have a larger size opening (about 6.75 mm). The second gas manifold 37, supplies gas to the two inner gas orifices 42 having a smaller size opening (about 2.25 mm). To use the burner unit on the high setting, gas is supplied to both gas manifolds 36, 37. To use the burner unit on the low setting, gas is supplied only to one gas manifold 37, preferably the one which services the two smaller orifices. While a variety of gas orifice sizes may be used, it is preferred that the smaller orifices are #68, or 0.301 inches, and that the large gas orifice size is #57, or 0.0430 inches. Additionally, optimal performance is obtained when the gas manifold pressure is between 5 and 15 w.c. (water columns) as measured by a propane tank regulator, but preferably at 15 w.c.

As shown in FIG. 18, the low mode setting uses only one gas manifold 36 to supply the smaller outer gas orifices in the burner unit. The smaller gas orifices provide gas at approximately 8,000 BTU/H, for a total of 16,000 BTU/H for the low setting. In FIG. 18a, the high mode setting shows the use of both gas manifolds 36, 37 to supply the additional inner gas orifices at approximately 15,000 BTU/H each, or 30,000 BTU/H in total. Thus, the total gas use for all four gas orifices used during high mode operation is approximately 46,000 BTU/H.

It is believed that during operation of the burner unit in low mode, the one gas manifold 36, when in off condition, permits a small amount of gas to escape the plenum through the gas orifices. To avoid the loss of this escaping gas, a small amount of gas is permitted to pass through the gas manifold 36 and through the smaller inner orifices, to act as a wall and prevent escaping gas.

The use of the high-low settings in the burner unit of this application eliminates the need for moving the food closer to and farther away from the radiant gas burner unit to achieve different cooking temperatures.

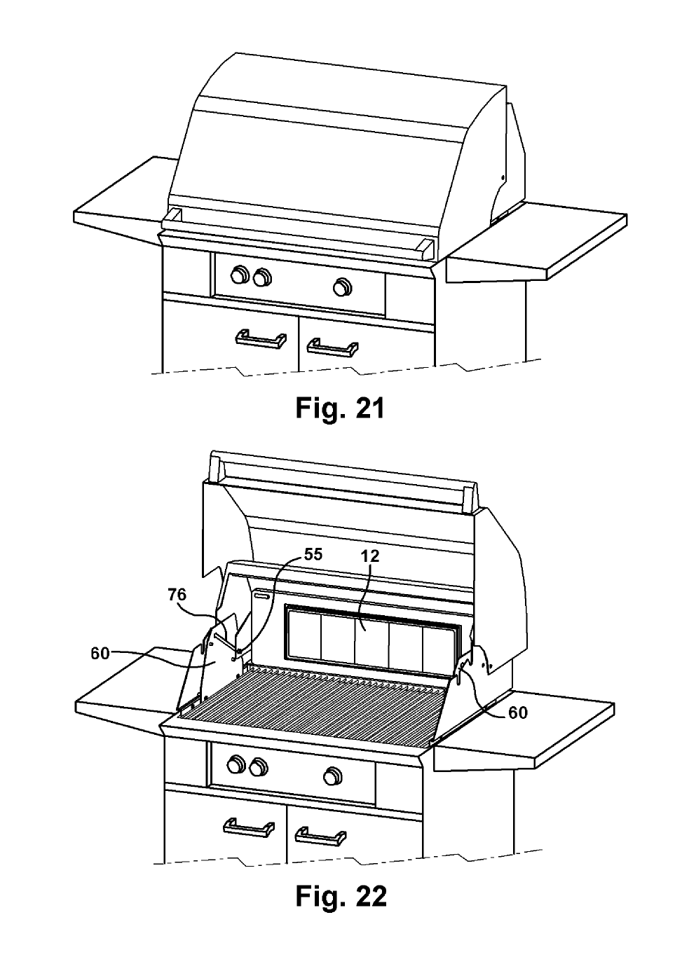

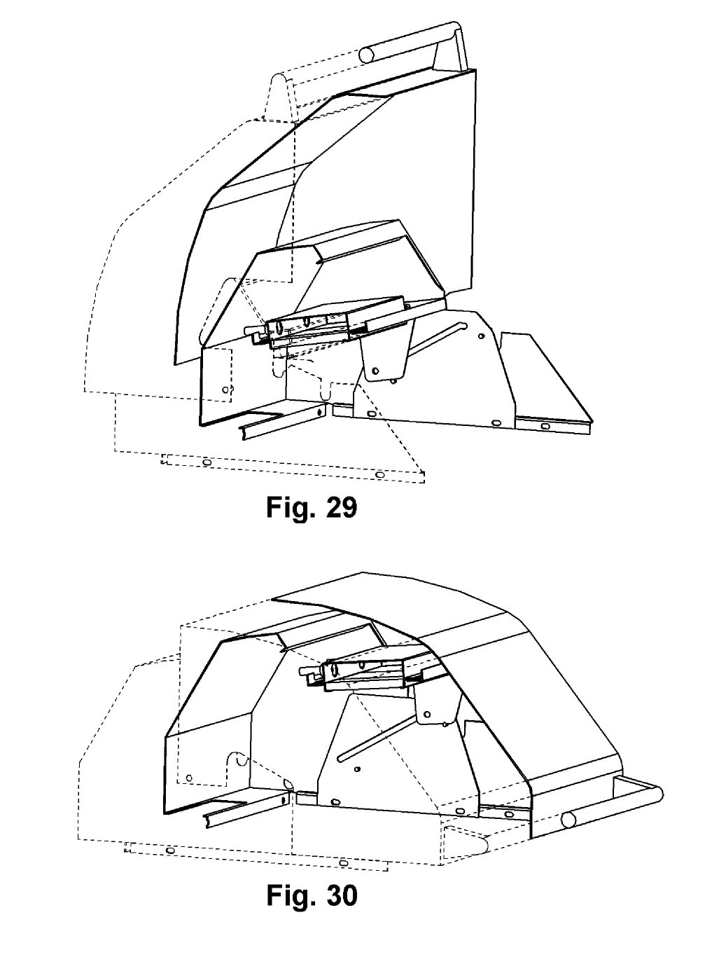

A still further third alternate embodiment of the present adjustable grilling apparatus 10 is illustrated in FIGS. 21 to 30. In this embodiment, the infrared radiant burner unit 12 may be completely enclosed within the grill G when the hood L is closed as shown in FIG. 21.

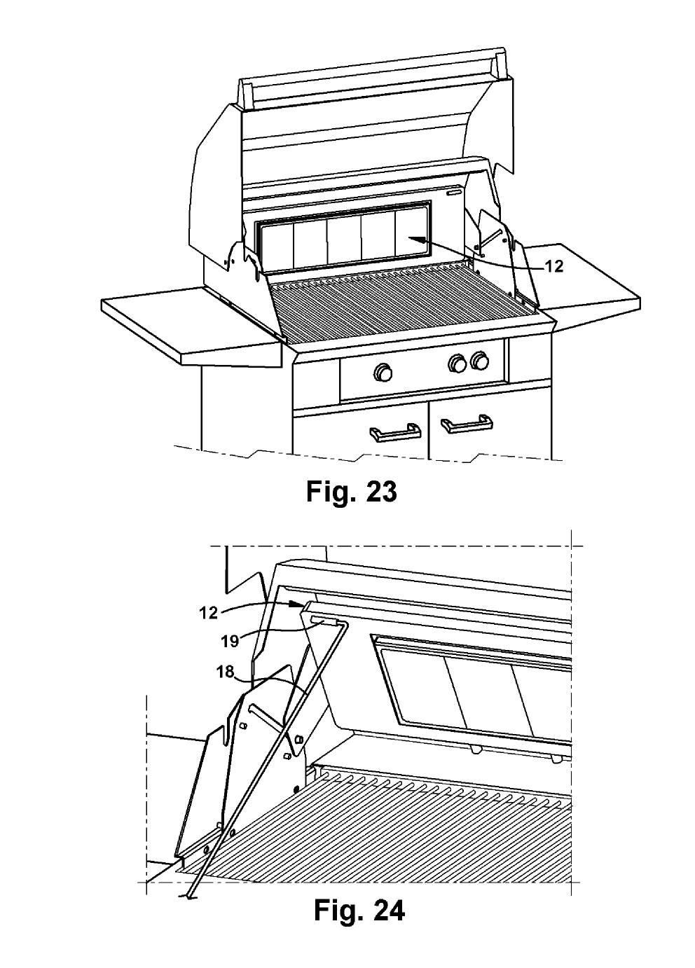

With the grill G hood L open, the burner unit 12 can be seen in FIG. 22. As in the prior embodiments, the infrared radiant burner unit 12, either gas or electric, has two long side walls 14 and two shorter side walls 16 and the unit 12 includes a box frame member 13. As shown in FIG. 24, an anchoring tube 19 is welded to the box frame member 13, and a handle 18 for rotating or translating movement of the burner unit 12 may be provided at the front of the box frame member. The handle is simply inserted into the anchoring tube when it is desired to move the burner unit 12, and removed once the desired position is achieved. As in the prior embodiments, side panels 54a, 54b are provided on the box frame member 13, as shown in FIGS. 23-25. The side panels 54 include a pivot opening 55, and are secured via welding or conventional fasteners to the box frame member 13.

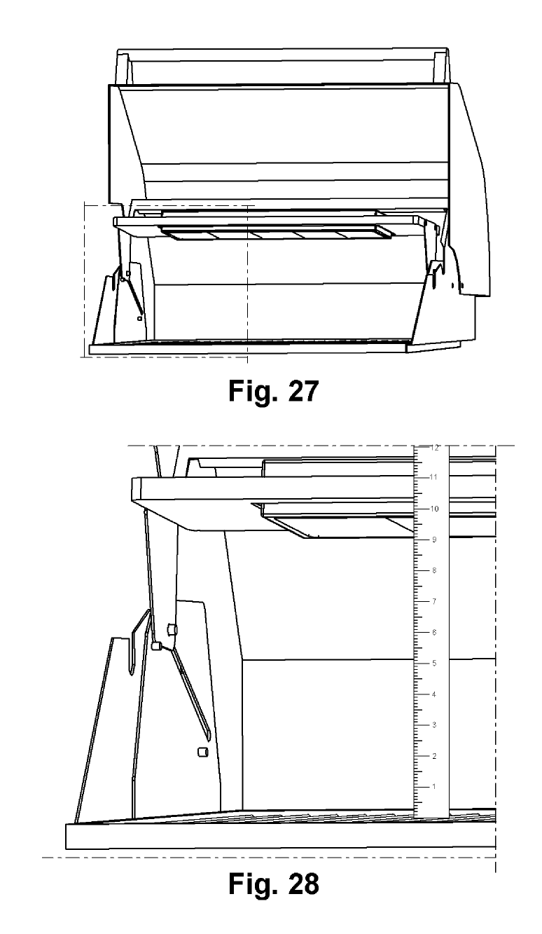

Corresponding support panels 60 are also shown in FIGS. 23-25 as provided adjacent each side panel 54. The support and side panels 60, 54, respectively, are engaged together for pivoting and translating engagement along a translating slot 76 at the pivot opening 55 via a post or conventional fastener as shown. The support panels 60 are supported within the grill G supported on the grilling rack R. Two outer stops 72 are provided which extend from the base of each support panel 60 for supporting engagement of the burner unit 12 on the grill G rack R. An inner stop 74 extending from each support panel 60 engages the side panel 54 to support the burner unit 12 when it is moved to an upper broiler location or position, as shown in FIGS. 27, 28 and 30. It should be understood that the stops indicated may extend from either surface of the support panel 60, depending on the grill dimensions. In the rotisserie location, the burner unit 12 is supported along the rear surface of the grill G, as shown in FIG. 14.

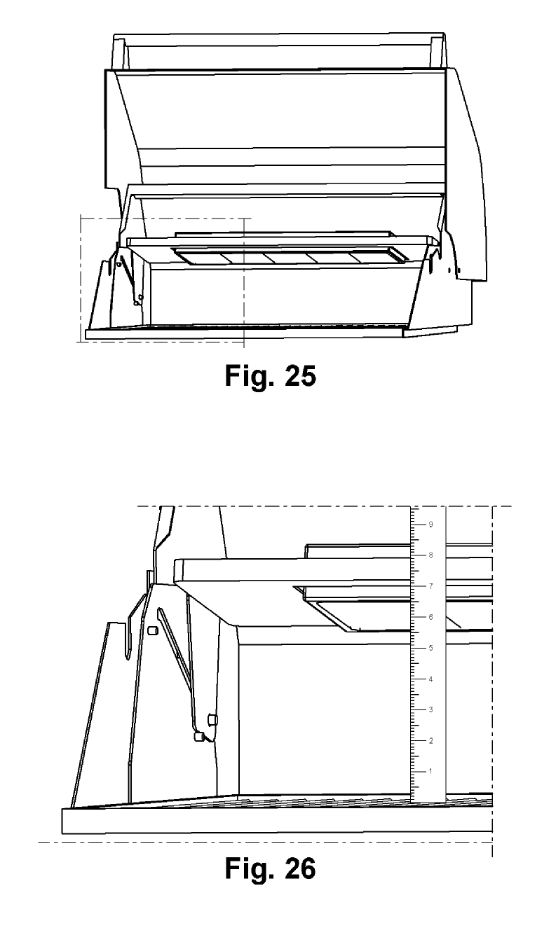

As shown by a comparison between the first and lower broiler position in FIG. 25 and the second and higher broiler position in FIG. 27, the handle 18 is used to translate the burner unit 12 from a lower broil position at a lower end of the translating slot 76 to a higher broil position at a higher end of the translating slot 76, where the burner unit 12 rests on the inner stop 74. In this second broil position, the grill hood L may still be closed. In the first broil position, the food clearance between the surface of the burner unit and the grill rack R is about 6.0 inches, while in the second broil position, the food clearance between these same to surfaces is about 9.5 inches. Thus, a larger cooking area is available when necessary.

In a gas use embodiment of the infrared gas burner unit, in order to prevent hot flue gas from entering the gas inlets of the adjustable gas burner unit when the bottom grill burner is on, and from overheating the gas connection lines, a flexible metal shield extended from the bottom of the adjustable grilling apparatus may also be used. The thin, flexible, sheet metal shield 77, shown schematically in FIGS. 17a and 17b, should slide up and down through a horizontal slot formed near the back of the grill as the infrared gas burner unit shifts between different positions. In particular, most of the thin sheet metal shield should be stored below the surface of grill rack R when the gas burner unit 12 is in the rotisserie position.

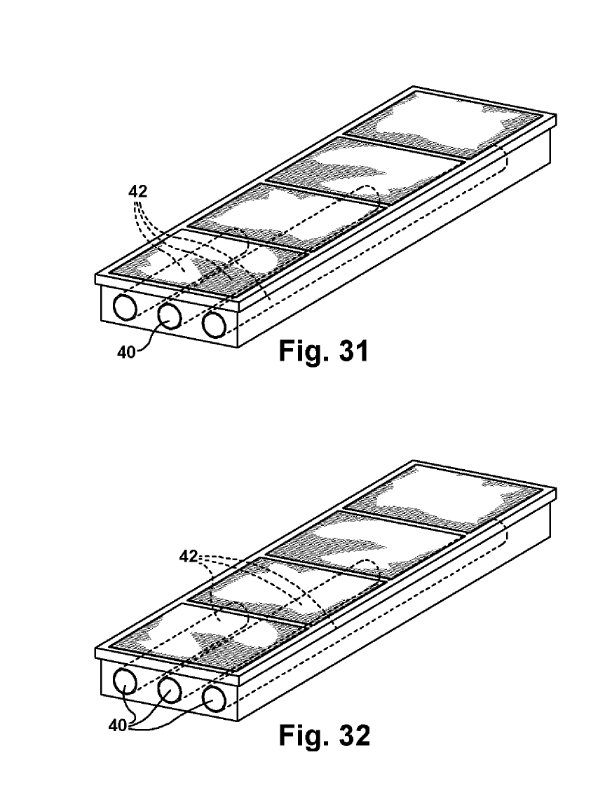

Still another solution for avoiding the interference of hot flue gas is provided as shown in the alternate embodiment of FIGS. 31 and 32. In this embodiment, the gas inlets are provided at the short wall or side of the gas burner unit 12. Instead of supplying gas through multiple inlets along the long wall of the burner unit, the gas inlets are provided through multiple inlets along the one or both of short walls to mixing tubes 42 having variable lengths, as shown. In this way, the gas inlet ends of the mixing tubes are readily protected because they are covered by the burner frame 13. In the low gas control mode of FIG. 31, gas is only supplied to one of the gas jets. In the high gas control mode of FIG. 32, gas is supplied to all 3 or more of the gas jets.

Additional advantages and modifications to the present adjustable grilling apparatus 10 will be readily apparent to those skilled in the art. The invention in its broader aspects is therefore not limited to the specific details or representative examples described. Accordingly, while care has been taken to provide details concerning the specific preferred features of the present adjustable grilling apparatus, departures may be made from the detail described here without departing from the spirit or scope of the disclosed general inventive concept and the following claims.

We claim:

1. An adjustable grill apparatus comprising:
a movable radiant burner unit and a support assembly having a grill rack for supporting a food item to be cooked,
the movable infrared radiant burner unit supported on the support assembly for adjustable positioning between a substantially vertical position supported on the support assembly and a substantially horizontal position supported on the support assembly, and
the infrared radiant burner unit has a high heat mode and a low heat mode.

2. An adjustable grill apparatus comprising:
a movable radiant gas burner unit having a base with first and second long walls and two shorter walls, with the long walls having a longer dimension than the shorter walls, and the base supporting an infrared radiant burner plate having openings therethrough, the infrared radiant burner plate forming an external surface of the base supporting high temperature infrared radiant combustion;
at least four mixing tubes, each having a central axis aligned with the shorter walls, the mixing tubes partially supported within the base spaced from one another, and having two open ends, with the first open end positioned within the base and the second open end extending through corresponding openings formed through the first long wall of the base;
a first gas supply extending transversely with respect to the first long wall and having gas outlets positioned along the gas supply at locations aligned with and spaced from the open ends of the outermost mixing tubes to receive a desired gas supplied by the first gas supply which is mixed with air at a predetermined desired ratio as the air/gas mixture enters the mixing tubes and is substantially evenly supplied to and through the openings of the infrared radiant burner plate to provide a first operating temperature when gas is supplied to the first gas supply;
a second gas supply extending transversely with respect to the first long wall and having gas outlets positioned along the gas supply at locations aligned with and spaced from the open ends of the innermost mixing tubes to receive a desired gas supplied by the second gas supply which is mixed with air at a predetermined desired ratio as the air/gas mixture enters the mixing tubes and is substantially evenly supplied to and through the openings of the infrared radiant burner plate to provide a second operating temperature when gas is supplied to the first and second gas supplies;
the movable radiant burner unit adjustably supported on a support assembly for adjustable positioning between a substantially vertical position supported on the grill rack and a substantially horizontal position supported on the support assembly.

3. The adjustable grill apparatus of claims 1 and 2, wherein the support assembly is positioned on the top cooking surface of a conventional outdoor grill.

4. An adjustable grill apparatus comprising:
a movable radiant burner unit and a support assembly for supporting the movable radiant burner unit in a desired position adjacent a food item to be cooked,
the movable radiant burner unit supported on the support assembly for adjustable use of the unit for searing, broiling, grilling and rotisserie cooking of the food item to be cooked.

5. A movable infrared radiant burner unit for a cooking grill comprising:
a base having a long wall and a shorter wall, the base supporting an infrared radiant burner plate having perforations therethrough, and the infrared radiant burner plate forming an external surface of the base for emitting high temperature radiation;
at least three mixing tubes substantially aligned with respect to the shorter wall, and having two open ends, the first open end positioned within the base and the second open end positioned adjacent openings formed through the long wall of the base;
a flexible gas supply extending along the long wall and having gas outlets for ejecting gas from the gas supply and across an open air gap positioned intermediate the gas outlet and the second open ends of the mixing tubes, the ejected gas is mixed with air at a predetermined desired ratio and provided through the perforations of the radiant gas burner plate to emit high temperature radiation along the external surface of the base; and
a handle portion extending from a long wall of the base for moving the gas burner unit to a desired position.

6. A support assembly for a grill for supporting a food item to be cooked comprising:
a top plate having an opening for engagement with an infrared radiant burner unit,
first and second side plates, each having a pivot opening, and spaced from one another and vertically extending from the top plate, and
first and second support plates positioned adjacent each side plate, having a pivot opening for pivotal engagement with each side plate supported on a pivot pin, each having first and second supports extending from the support plates away from each side plate for supporting the support assembly on a grill, and a position pin extending towards the other support plate, for engaging the side plate and supporting the top plate at desired positions, including a substantially horizontal position over the food item to be cooked.

7. The support assembly as set forth in claim 6, wherein each support plate includes a translating slot supporting the pivot pins and for moving the top plate from a first position to at least one second position.

8. The support assembly as set forth in claim 7, wherein a handle extends from the top plate for manually moving the top plate between positions.

9. The support assembly as set forth in claim 7 wherein the top plate is movable between and enables use of the infrared radiant burner unit in at least 3 cooking positions.

10. The support assembly as set forth in claim 8, wherein a flexible metal shield extends from said top plate in a direction away from the handle.
